(19) United States
(12) Patent Application Publication
(10) Pub. No.: US 2022/0072467 A1
(43) Pub. Date: Mar. 10, 2022

(54) SYSTEM AND METHOD FOR CONDITIONING GAS FOR DOWNHOLE APPLICATIONS

(71) Applicant: GTUIT, LLC, BILLINGS, MT (US)

(72) Inventors: James Haider, Helena, MT (US); Brian Cebull, Billings, MT (US); Mark Peterson, Helena, MT (US); Stephen Doll, Big Arm, MT (US); Austin Vandelinder, Billings, MT (US)

(21) Appl. No.: 17/015,323

(22) Filed: Sep. 9, 2020

(51) Int. Cl. B01D 51/10; E21B 43/12; B01D 53/30; B01D 53/26; C10L 3/10

(52) U.S. Cl. CPC B01D 51/10; E21B 43/122; B01D 53/30; B01D 53/26; C10L 2290/06; C10L 3/106; C10L 2290/08; C10L 2290/30; C10L 3/101

(57) ABSTRACT

A method for conditioning natural gas for downlink applications comprising pulling raw gas; cooling the gas to a temperature within a preset temperature range; removing solid contaminants and condensed liquids from the gas; reducing gas pressure to meet the requirements of the inlet side of a compressor; controlling the rotational speed of the compressor based on data input from various flow meters; delivering the preconditioned gas to the suction side of the compressor; elevating gas pressure to achieve a desired discharge pressure; using an aerial cooler to cool the pressurized gas; delivering the pressurized gas to a separator to separate the liquids from the gas; repeating the compression, cooling and separating steps until desired temperature and pressure are achieved; cooling the gas through the use of a heat sink; removing liquids from the gas through the use of a separator; and adjusting the final gas pressure and temperature.

### BACKGROUND OF THE INVENTION

### 1. Field of the Invention

The present invention relates generally to the field of oil and gas production, and more specifically, to a system and method for conditioning gas for downhole uses, including, but not limited to, artificial gas lift.

### 2. Description of the Related Art

After an oil well is completed, high pressures in the formation cause fluids to flow out of the well. The formation pressure will “push” the oil out of the well naturally for a while, requiring no assistance to get it to come to the surface. This process is known as a flowing well; however, as time progresses, the formation pressure depletes. At some point, this lowered pressure will slow the flow of oil down so significantly that an operator must deploy some means of “lifting” the fluids to the surface. Although there are several options available to operators, including rod pumps (powered by pump jacks on the surface), electric submersible pumps (ESPs), and gas lifts, each option allows for very little control over the process itself The lack of control, particularly for gas lift, creates challenges for operators in terms of decreased production and reliability.

Gas lift is a method of artificial lift that uses an external source of high-pressure gas for supplementing formation gas to lift the well fluids. There are two main types of gas lift—continuous and intermittent flow. With continuous flow gas lift wells, gas is injected continuously into the production conduit at a maximum depth that depends on the injection-gas pressure and well depth. This injection gas mixes with the produced well fluid and decreases the density and flowing pressure gradient of the mixture from the point of gas injection to the surface. This decreased flowing pressure gradient reduces the flowing bottom hole pressure below the status bottom hole pressure, thereby creating a pressure differential that allows the fluid to flow into the wellbore.¹ The injection gas is typically conveyed down the tubing-casing annulus and enters the production train through a series of gas-life valves. The gas-lift valve position, operating pressures and gas injection rate are determined by specific well conditions.²

There are a number of issues that cause complications for operators when working with a gas lift, including the details of the gas injection itself. In order to maximize production, three conditions need to be optimized by the producer. These parameters are gas pressure, gas temperature, and gas flow rate. When working with engine-driven reciprocating compression, there is very little control of these parameters. Even though pressure and flow rate are mechanically regulated, the process has historically been performed in a very primitive manner. Typically, producers inject gas by using a mechanical choke so that they can regulate both flow rate and pressure together, causing an unreliable outcome with an inconsistent amount of production. Because of the Joule-Thomson (JT) effect, the pressure drop across the choke may also affect gas temperature in a manner that is not controllable by the operator. When rich gas is used, inconsistencies in temperature can cause many issues at the choke, including freeze-up and hydrate formation.

The present invention solves this problem by providing a system and method that allow the three key parameters—gas pressure, gas temperature, and gas flow rate—to be controlled independently. Most of the inventions discussed below are directed toward improving gas lift in some manner, but all of these inventions are distinguishable from the present invention.

U.S. Pat. No. 5,634,522 (Hershberger, 1997), U.S. Pat. No. 5,826,659 (Hershberger, 1998), U.S. Pat. No. 6,516,879 (Hershberger, 2003) and U.S. Pat. No. 6,705,397 (Hershberger, 2004) disclose a method of producing gas through liquid level detection in oil or gas wells using various types of artificial lift systems. These systems include sub-surface gas lift, beam pumps, progressive cavity pumps and submersible pumps. The artificial lift systems are controlled in response to a known liquid level within the well bore to prevent the well from pumping off and damaging the artificial lift system or from reducing the liquid level in the well bore to an unnecessarily low level, thereby increasing the energy required to remove the liquid from the well bore.

U.S. Pat. No. 5735246 (Brewer, 1998) provides an artificial lift control system that utilizes a piggy back line, flow computer, pressure transmitter, and software control to control the artificial lift of wellbore fluids. The piggy back line is a medium- to high-pressure line strapped to the outside of the tubing. Supply, make-up gas or other fluids are pumped down the piggy back line at the lowest flow rate possible, and a pressure or differential pressure transmitter is installed to monitor pressure on the piggy back line or to measure the different pressure between the piggy back line and the casing pressure. The flow computer monitors pressures or differential pressures and uses software instruction sets to calculate fluid levels in the casing tubing annulus. The flow computer cycles the artificial lift on and off based on parameters set in the software.

U.S. Pat. No. 6,167,965 (Bearden el al., 2001) describes an improved electrical submersible pump in which a downhole processor is used to minor one or more subsurface conditions, to record data, and to alter at least one operating condition of the electrical submersible pump. Sensors detect at least one of a pump operating attribute, a subsurface condition, a fluid flow attribute, and a fluid attribute, and operation of the pump is controlled based on these measurements.

U.S. Pat. No. 6,679,332 (Vinegar et al., 2004) discloses a petroleum well with an electronic module and a number of sensors that communicate with the surface using the tubing string and casing as conductors. Induction chokes at the surface and downhole electrically impede AC flow through the tubing or casing with the resulting voltage potential useful for power and communication. A high bandwidth, adaptable spread spectrum communications system is used to communicate between the downhole electronics module and a surface master spread spectrum modem.

U.S. Pat. No. 9,234,410 (Lemetayer, 2016) provides a method for controlling a hydrocarbons production installation in which a hydrocarbons production string is activated by a gas injection using a gas injection choke and a production choke on the string. The position of at least one of the chokes is adjusted by cascaded control loops, which are driven accordingly to continuously or sequentially developing setpoint parameters. The cascade control loop architecture makes it possible to simplify each of the loop in order to increase the speed of implementation while still taking account of a greater number of setpoint parameters.

U.S. Pat. No. 9,863,222 (Morrow et al., 2018) describes an electro-acoustic system for downhole telemetry that employs a series of communications nodes spaced along a string of production tubing within a wellbore. The nodes allow for wireless communication between transceivers residing within the communications nodes and a receiver at the surface. The signals sent from the nodes to the receiver are analyzed to determine gas lift valve operation and fluid flow data.

U.S. Pat. No. 10,077,642 (Elmer, 2018) discloses a gas compression optimization system and a method for optimizing gas injection rate in support of a gas lift operation. The system includes a string of production tubing, an annular region around the production tubing, and a production line at the surface. A pressure transducer is used to determine a differential pressure across an orifice plate placed along the production line. A gas injection line at the surface is configured to inject a compressible fluid in to the annual region. A controller is configured to control the injection of the compressible fluid into the annual region in response to differential pressure signals.

U.S. Patent Application Pub. No. 20100088139 (Rahi et al.) provides a method for planning and managing project plans in which the project involves managing machinery to extract hydrocarbons from downhole formations. In one embodiment, the oilfield includes a first producing well that uses an electric submersible pump, a second well that relies on a gas lift to produce a hydrocarbon, and a third well that relies on natural flow to produce a hydrocarbon. All three wells deliver production fluids (e.g., hydrocarbon) to a production manifold, which collects multiple streams and outputs the streams to a gas and oil separator. The gas and oil separator separates various components from the fluids, such us produced water, produced oil, and produced gas, respectively, to a water disposal well, oil storage, and a compressor station. Oil storage transfers oil via an oil export pipeline, the compressor station uses the gas export pipeline to transfer gas, and the compressor station processes gas as an injection gas. The meter and control system regulates pressure of the injection gas as it is delivered to a wellhead tubing and casing.

U.S. Pat. No. 8,571,688 (Coward, 2013) describes a system and method for optimization of gas lift rates on multiple wells. The method includes controlling a lift-gas compression process using a lift-gas compression process control system, controlling a lift-gas extraction process using a lift-gas extraction process control system, controlling a production separation process using a production separation process control system, receiving process-related data associated with one or more of the processes and material from one or more reservoirs associated with the wells, and optimizing the processes based on the process-related data. An optimal gas lift rate is expressed as a quadratic optimization target for each gas lift rate and based on differences between actual and desire resting values of multiple controlled and manipulated variables.

U.S. Patent Application Pub. No. 20170343986 (Zhang et al.) discloses a system for enhancing the flow or a fluid induced by a gas lift system, including one or more sensors and a gas lift control unit. The gas lift control unit receives measured data from one or more sensors; calculates a desired gas injection rate and its associated flow of fluid based on the measured data; regulates at least one operating characteristic of a compressor associated with the gas lift system based on the desired gas injection rate; receives production data; and determines a subsequent adjustment based on a comparison of the desired fluid flow and production data.

U.S. Patent Application Pub No. 20180016880 (Elmer) provides a gas compressor system that injects a compressible fluid into a wellbore in support of a gas-lift operation. The system includes automated individual control of discharge temperatures from coolers for gas injection, in real time, wherein the temperature control points of the first and/or second stage cooler discharges are automatically controlled by a process controller in order to push heat produced by adiabatic compression to a third or final compression stage. In this manner, discharge temperatures at the final stage are elevated to maintain injection gaseous mixtures in vapor phase.

U.S. Patent Application Pub. No. 20180149002 (Murdoch et al.) describes a method for the injection of a lift gas into a wellbore production string comprising the steps of determining production pressure within the production string and autonomously controlling a variable orifice gas lift valve in accordance with the determined production pressure. The variable orifice gas lift valve controls the injection flow rate of the lift gas into the production string.

### BRIEF SUMMARY OF THE INVENTION

The present invention is a method for conditioning natural gas for downhole applications comprising: pulling raw gas from a source; cooling the raw gas to a temperature within a preset temperature range for an inlet of a compressor; removing any solid contaminants and condensed liquids from the raw gas to produce preconditioned gas; determining pressure requirements of a suction side of a compressor; reducing pressure of the preconditioned gas to meet the requirements of the suction side of the compressor using a first automated pressure regulator; wherein the compressor has a rotational speed, controlling the rotational speed of the compressor based on data input from a flow meter located downstream of the compressor, a flow meter located upstream of the compressor, and one or more transducers located on the suction side of the compressor; delivering the preconditioned gas to the suction side of the compressor; elevating pressure of the preconditioned gas to achieve a desired discharge pressure and generate pressurized gas; using an aerial cooler to cool the pressurized gas, thereby causing liquids to form; delivering the pressurized gas to a separator to separate the liquids from the preconditioned gas; repeating the steps of elevating pressure of the preconditioned gas through a series of compression stages to achieve a desired discharge pressure and generate pressurized gas, using an aerial cooler to cool the preconditioned gas, and delivering the preconditioned gas to a separator to separate liquids from the preconditioned gas until a gas stream having a desired gas temperature and a desired pressure is achieved; cooling the pressurized gas by using a first temperature sensor to send a signal to the programmable automation controller to maintain a desired temperature set by an operator and generate cooled gas through the use of a heat sink; removing liquids from the cooled gas through the use of a separator to generate conditioned gas; wherein the conditioned gas has a pressure, adjusting the pressure of the conditioned gas by using a pressure sensor located in the gas stream to send a gas supply pressure signal to the programmable automation controller and using the programmable automation controller to control a second automated pressure regulator to adjust the pressure of the conditioned gas without affecting the flow rate of the conditioned gas; and adjusting the temperature of the conditioned gas by using a second temperature sensor situated in the gas stream to send a signal to the programmable automation controller to increase the temperature of the conditioned gas using an automated injection valve situated between the series of compression stages and a heat exchanger to achieve an exit temperature specified by the operator for the conditioned gas. In an alternate embodiment, the invention comprises the further step of removing water from the pressurized gas through the use of a dehydration method.

The present invention is also a system for conditioning natural gas for downhole applications comprising: a programmable automation controller configured to accept operator-input specifications for desired gas outlet pressure, desired gas outlet temperature, and desired gas outlet flow rate and to independently control each of these three parameters; one or more gas pressure sensors, one or more gas temperature sensors, and one or more gas flow meters configured to transmit data to the programmable automation controller; a first aerial cooler configured to adjust temperature of pre-conditioned gas; a first separator configured to remove liquids from the pre-conditioned gas; a first automated pressure regulator configured to regulate inlet pressure of the pre-conditioned gas; a compressor having a first stage of compression with a variable volume pocket, the compressor being configured to receive and compress the pre-conditioned gas, thereby increasing pressure and temperature of the pre-conditioned gas to generate pressurized gas; an external heat sink configured to decrease temperature of the pressurized gas to generate conditioned gas; a second automated pressure regulator configured to reduce pressure of the conditioned gas to the desired gas outlet pressure; and a heat exchanger configured to increase temperature of the conditioned gas to the desired gas outlet temperature; wherein the PAC is further configured to control pressure, rotational speed and pocket size of the compressor to achieve the desired outlet gas flow rate.

In a preferred embodiment, the compressor has one or more compression stages, and the invention further comprises an additional aerial cooler and an additional separator for each additional stage of compression beyond the first stage of compression. Optionally, the system further comprises a gas dehydration unit configured to remove water from the pressurized gas.

### BRIEF DESCRIPTION OF THE DRAWINGS

FIG. 1 is a system architecture diagram of the present invention.

FIG. 2 is a continuation of the system architecture diagram of the present invention.

FIG. 3 is a flow diagram of the safety logic employed as part of the present invention in determining whether the system is ready to begin pulling raw gas from a source.

FIG. 4 is a flow diagram of the steps entailed in cooling the raw gas and removing from the raw gas any solid contaminants and condensed liquids to produce preconditioned gas.

FIG. 5 is a flow diagram of the iterative steps entailed in staged compression and cooling of the preconditioned gas;

FIG. 6 is a flow diagram of the optional step of dehydrating the pressurized gas and the step of cooling the pressurized gas.

FIG. 7 is a flow diagram of the steps of adjusting the pressure and temperature of the conditioned gas.

FIG. 8 is a flow diagram of inputs to the programmable automation controller.

### DETAILED DESCRIPTION OF INVENTION

### A. Overview

Gas compression is used on oil and gas locations for many different operations, one of which is the lifting of fluids to the surface. Gas lift is a means of injecting high-pressure natural gas down the back side of a well's tubing, allowing the injected gas to bubble through the tubing at specific locations and into the fluids produced by the well. This bubbling has the effect of lifting the fluids to the surface by reducing the bottom hole flowing pressure. Gas compression units comprised of a gas-driven reciprocating engine and positive displacement compressor are commonly used for this application. The gas that is both burned in the engine and compressed in this typical system needs to be relatively clean, which means that it is rich in methane and low in other gaseous and non-gaseous constituents. in many cases, pipeline-quality natural gas is purchased by the well operator and used for this purpose; however, natural gas produced at the wellsite is preferred because of its low cost and availability at the point of use. Wellsite natural gas is less optimal for reciprocating engines, however, as these engines function best with clean, dry gas. Wellsite gas tends to be dirty and wet, both with heavier hydrocarbons and water.

Gas lift has been used in the oil and gas industry for many years without the ability to control flow temperature or pressure. The use of gas lift is a basic process in which high-pressure natural gas is injected down the back side of the tubing of a well to lift fluids to the surface. Gas lift valves arc typically placed at strategic points in the well bore, but as the wells change dynamically over time, the operators are unable to control the flow rate and pressure in a meaningful way to optimize oil recovery. The use of crude mechanical controls limits their options when trying to recover fluids from a low-pressure well.

The present invention allows for the independent control of the three key parameters required for gas supplied for downhole uses: temperature, pressure and flow rate. With this present invention, operators can field-adjust the parameters for temperature, pressure, and flow rate of gas to be supplied to their gas lift or other downhole operation. In addition, the invention is able to remove water from the gas in order to prevent freezing and hydrate formation in downhole activities. By utilizing this extra control, the operator is able to maximize artificial lift and any other downhole operations efficiencies.

The present invention utilizes a programmable automation controller (PAC), which manages electrically-driven gas compressors that are regulated by variable frequency drives (VFD) to produce a field-selectable flow rate of gas. The PAC also controls a pressure regulation valve, which in turn controls the delivered pressure of the gas. The PAC also controls either VFD-modulated ambient air cooling or VFD-modulated mechanical cooling to adjust gas temperature. With the present invention, variation of any one of the three key parameters does not affect the other two. The present invention provides the operator with field-adjustable and independent control of all three key parameters. The combination of computer control with proprietary software and electronically modulated components provides a solution that replaces the industry-standard engine-driven reciprocating compressor and mechanical choke combination for supplying consistent gas on the well site.

The method of the present invention includes the steps of (a) raw gas conditioning, (b) compression with flow rate control and liquids separation, (c) optional dehydration, (d) gas cooling with liquids separation, (e) final compressed gas temperature adjustment, and (f) final compressed gas pressure control. As used herein, the term “rich” gas means natural gas that is comprised of a mixture of methane, ethane, and longer chain organic compounds that can condense into liquids at some pressure/temperature condition during the gas lift process. Rich gas is also referred to as raw gas, associated gas, or wellhead gas.

In conventional compression systems, the three parameters of flow rate, pressure and temperature are typically connected so that if you change one of these parameters, the other two are affected. For example, when the flow rate of a typical gas compression system is changed, the gas cooling system—typically comprised of an aerial cooler and fixed speed fan—will cool the compressed gas to a lower temperature because there is less flow. This is because the fan removes a fixed amount of heat per minute, but there are fewer cubic feet of gas per minute to cool; therefore, the exit temperature is reduced. Similarly, if the compressor's outlet pressure is increased, the heat of compression is proportionally increased, causing the resultant gas temperature to rise. The same effect would occur when output gas pressure is lowered, with the result being lower gas temperature. Additionally, the flow of a reciprocating compressor is usually limited by the fixed speed nature of a gas-fired engine. The present invention utilizes an electric motor with VFD, which allows for wider flow variations by changing the compressor speed in addition to inlet pressure and pocket size. All of these issues are overcome with the present invention.

The first step in the method of the present invention is raw gas conditioning. Raw (or rich) gas is an unspecified mix of constituents (starting point) for gas lift. Traditional gas lift systems are commonly built to run on “pipeline gas,” which is a defined input because there is a generally accepted specification for pipeline-quality gas, and it has very little water or any other condensable components. By contrast, the present invention is designed to work with an undefined input; for this reason, the first step is to bring the gas stream to a predictable composition, pressure, and temperature. The raw gas conditioning system consists first of an aerial cooler to cool the gas close to ambient temperature. If the gas is already cooler than ambient temperature, this component is bypassed. By cooling the gas to ambient temperature, condensable components, such as water, change phases from a gas to a liquid.

The next component (after the aerial cooler) in the raw gas conditioning step is a two or three-phase separator that removes any condensed components and any solid contaminants that may exist in the raw gas. The decision whether to use two- or three-phase separation will be determined by the locations of operation and the convenience of keeping water separate or mixed with other produced liquids. This separation fixes the minimum operating temperature and pressure for the dewpoint of the gas. As used herein, the term “dewpoint” refers to the position on a vapor liquid equilibria phase envelope at which the first drop of liquid may form by a reduction in temperature and/or increase in pressure. If necessary, gas pressure is reduced to meet the requirements of the suction side of the gas lift compressor.

The second step in the method of the present invention is gas compression with flow rate control and liquids separation. As gas enters the compressor at or above its dewpoint, the gas pressure is elevated using one or more compression steps. This can be accomplished with any type of compressor, including screw, reciprocating, or centrifugal compressors. During the process, the mechanical limitations of the compression device often create the need for multiple stages of compression to reach an adequate discharge pressure. The multiple stages of compression result in elevated temperatures because of the heat generated during compression. An aerial cooler is used to cool the gas, causing liquids to form due to the shift in temperature and pressure on the gas phase envelope. The gas then enters a separator, and liquids are separated from the gas. The compression, cooling and separation steps are repeated until the desired pressure is reached.

The process of gas compression with flow rate control and liquids separation is common to the gas industry; however, it has had limited effectiveness because the flow rate of the process has been fixed. Although some mechanical methods have been used to vary the flow rate, they have had limited effectiveness. The present invention improves and modernizes this procedure by allowing for a variable flow rate. It does this by utilizing an electric motor connected to and controlled by a VFD, which controls the rotational speed of a compressor. Flow rate through the compressor is determined by both a flow meter downstream of the compressor and pressure monitoring with transducers on the suction side of the compressor. (As used herein, the terms “transducers” and “sensors” are used interchangeably.) By utilizing data on both the inlet and the outlet, volume changes due to condensation between stages can be accounted for. These data are then analyzed by the PAC, which can then vary the rotational speed of the compressor via a VFD in order to maintain the desired flow rate within the power constraints of the motor.

The third step in the method of the present invention is dehydration. In a typical oil or gas well, there is some amount of water entrained in these fluids. Water is generally an unwanted byproduct of these recovered fluids, and steps are usually taken to reduce or remove water before further refinement or transportation is accomplished. The present invention removes water from the associated gas through the use of thermally regenerated desiccant or molecular sieve, pressure swing adsorption, glycol, methanol, or other dehydration methods. The operator has the ability to bypass this step altogether if it is deemed unnecessary or would incur other costs or inconveniences by creating an additional water waste stream.

The fourth step in the method of the present invention is gas cooling with liquids separation. After the gas is compressed and optionally dehydrated, it is then cooled by a refrigeration system. This system may use aerial cooling, Joule-Thomson cooling, mechanical refrigeration, absorption refrigeration, or any combination of these methods. The cooling process is accomplished without affecting the ability to set a specific flow rate or pressure for gas from the gas lift. The cooling system utilizes a temperature sensor in the gas stream that feeds a signal to the PAC, which will adjust other cooling system parameters to maintain precisely the desired temperature set by the operator. After cooling, some liquids may be formed, and these liquids are removed from the gas by a two-phase separator.

The fifth step in the method of the present invention is final compressed gas pressure control. After cooling (or during cooling if Joule-Thomson cooling is applied), the final pressure of the gas lift gas is adjusted using an automated pressure regulator and a pressure sensor that sends a specific gas supply pressure to the PAC. This pressure control will not have any effect on the flow rate or the temperature controlled by the PAC.

The sixth step in the method of the present invention is final compressed gas temperature adjustment. In most cases, the operator will want to move the gas conditions away from the dewpoint. This may be accomplished in one of two ways, either by lowering the gas pressure (usually undesirable since the general point of gas lift is to supply high-pressure gas to the wellbore) or by raising the gas temperature. The present invention utilizes a gas-to-gas heat exchanger to warm up the gas lift gas stream to the desired final temperature setpoint. It does this by using an additional gas temperature sensor to send a signal to the PAC. This controls a valve that will direct one of several available hot gas streams from the gas compressor (inter-stage gas heated by the act of compression but used for reheat before ambient cooling) through the gas-to-gas heat exchanger to warm the gas for the gas lift.

At the discharge of the system, the flow rate, pressure, and temperature of the gas are at the setpoints entered by the operator. Additionally, the operator is able to adjust any one of these parameters without affecting the others. The present invention then discharges the gas, and the operator can direct this gas to the existing gas lift operation on site. As described, the operator is able to vary the temperature, flow rate, pressure, and water content of the gas provided to the lifting system to optimize fluids production.

### DETAILED DESCRIPTION OF THE FIGURES

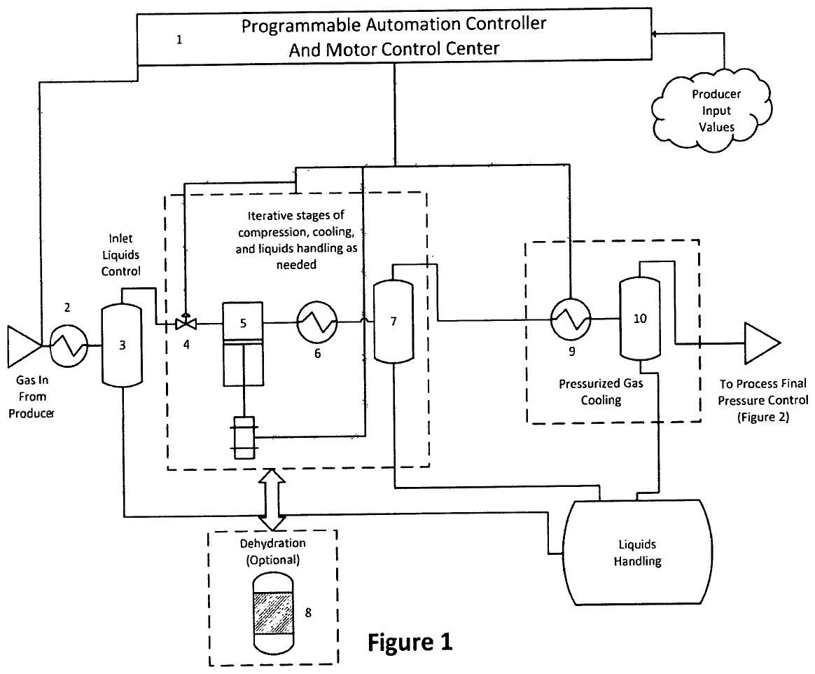

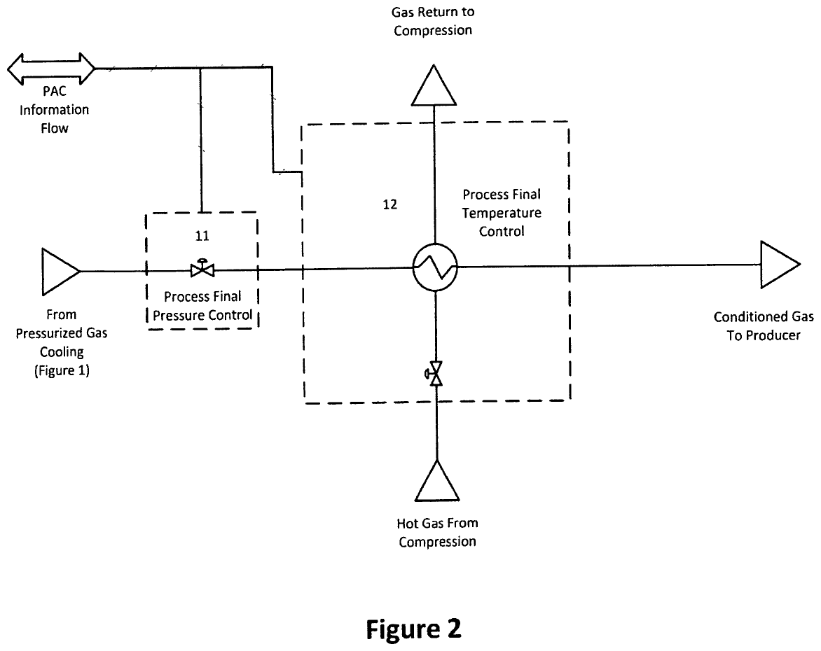

FIGS. 1 and 2 arc system architecture diagrams of the present invention. All processes within the invention are controlled by a programmable automation controller (“PAC”) 1. The operator's desired gas specifications for outlet temperature, outlet pressure and outlet flow rate are input into the PAC, and the resulting control signals are supplied to the equipment described below (specifically, the inlet pressure reduction valve 4, compressor 5, aerial cooler 6, external heat sink 9, automated valve 11 and process heating injection valve 12) to achieve the desired operating characteristics. First, a stream of gas is provided from a raw source, and this stream of gas is pre-conditioned using an aerial cooler 2 and separator 3 in order to bring its condition to a predictable state suitable for compression. Next, an automated pressure regulator 4 regulates the inlet pressure to the first stage of compression within the compressor 5. In a preferred embodiment, the compressor 5 has three stages of compression (these are physically segregated compression stages), and the invention includes a separate aerial cooler 6 and separator 7 for each stage of compression. Controlling the automated pressure regulator 4 and varying the speed and pocket size of the compressor 5 work together to set the inlet flow rate to the compressor.

The gas flow rate is monitored by flow meters that transmit data to the PAC, which in turn controls the compressor speed and pocket size. In a preferred embodiment, one flow meter is situated at the raw gas inlet, and another flow meter is situated at the outlet (see FIGS. 1 and 2). Pressure and temperature transducers are situated at the separator 3, the automated pressure regulator 4 and the compressor 5 and at various other locations throughout the system. These pressure and temperature transducers transmit data to the PAC, which uses the data to adjust the pressure, rotational speed and pocket size of the compressor 5 (more specifically, of each specific stage of compression within the compressor). These adjustments determine the outlet flow rate of the gas.

Once inside the first stage of compression within the compressor 5, the gas undergoes an increase in pressure and resultant increase in temperature. Next, the gas is cooled in an aerial cooler 6 and sent to a separator 7, where any entrained liquids are removed from the gas stream. The processes associated with components 5, 6 and 7 are reiterated (repeated) until the desired maximum pressure is reached. During these succeeding stages of compression, additional dehydration (preferably thermal or pressure swing adsorption desiccant dehydration) may be performed using a gas dehydration unit 8, if required. This additional dehydration may be required to prevent freezing or hydrate formation in the gas lift valving or piping.

After leaving the separator 7, the pressurized gas enters a final cooling stage. In this step, the gas is cooled to a minimum temperature using an external heat sink 9. This process may result in liquids formation; in that event, the gas is then routed into a separator 10, which removes any liquids present in the gas stream. After the separator 10, the gas undergoes its final pressure control, which is illustrated in FIG. 2. An automated pressure regulator 11 controlled by the PAC reduces the pressure of the gas to the operator's setpoint. Next, the temperature of the gas is increased to the operator's setpoint utilizing hot gas from the compression stages. (The number of compression stages in a typical embodiment ranges from two to six.) The hot gas from the compressor 5 is injected into a heat exchanger 12, which increases the temperature of the processed gas as the gas flows through it (the hot gas from the compressor and the processed gas do not mix within the heat exchanger). After this last step, the conditioned gas is at the operator's set temperature, pressure, and flow rate and is ready to be released to the end user.

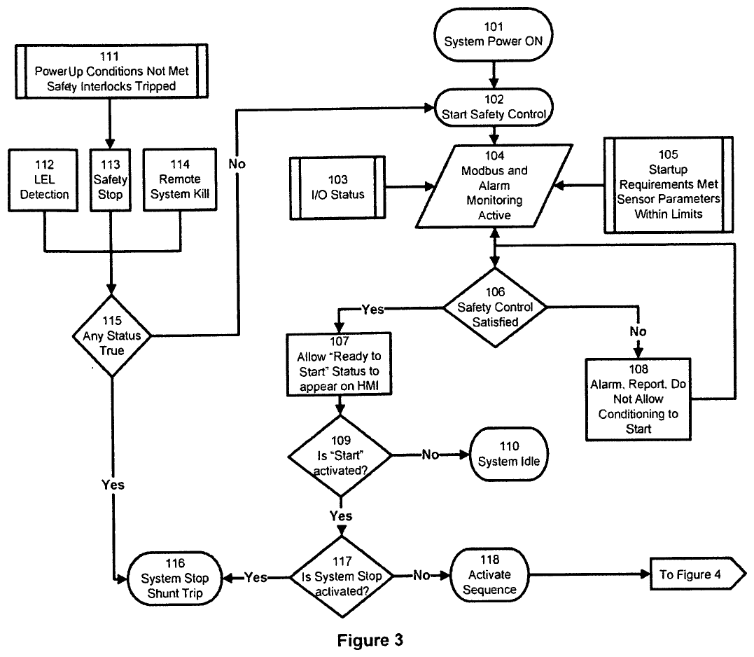

FIGS. 3-7 are flow diagrams of the PAC programming sequence of the present invention. As shown in FIG. 3, when initial power is applied, the PAC begins the Boot-Up process 101. The PAC then initializes the monitor for correct configuration and begins checking safety stop interlocks, combustible gas detection, and remote modbus values. If all initial values are within allowed parameters, the PAC allows system startup 102. Both analog and digital inputs and outputs used for control and operational decisions are used by the PAC. Discrete switch positions, analog temperatures, valve positions, and pressures are monitored by the PAC 103. The PAC continually monitors conditions to ensure ongoing safe operation 104. At step 105, the PAC assesses whether start-up requirements have been met based on both operator input (for example, as to system configuration and parameters for high and low limits) and sensor parameters (for example, regarding the state of the system).

If all preceding safety criteria are satisfied, the system transitions for startup to processing 106. As long as the safety control 106 is satisfied, the “Ready to Start” icon will appear on the human-machine interface (HMI). The system can stay in this mode indefinitely until the start icon is toggled. If at any time the safety status is no longer satisfied, the “Ready to Start” icon disappears, and the alternate path 108 is invoked until the issues are cleared 107. In the event that the safety control is no longer satisfied, alarms are generated, and a report is cued for send out to the remote monitoring network. An inhibit is also fed back into the process to prevent startup or continued operation 108, and at that point, the PAC monitors the status of the “Ready to Start” bit 109.

If the system is ready to run (i.e., the “Ready to Start” icon appears), but the “Ready to Start” icon has not pressed, the process will remain in “idle” mode indefinitely 110. Hardware safety interlocks must be satisfied to allow power to be applied to the system. This includes level switches, emergency stop push button switches, and lock out/tag out switches 111. A combustible gas detection (CGD) sensor is located in the same physical electrical enclosure as the PAC; this enclosure is separate and apart from the system described above. The CGD sensor monitors for a lower explosive limit (LEL) of 20% or greater to send a shutdown notice 112. Any of the safety interlocks from box 111 that fail will send a shutdown notice 113 to the PAC, which then initiates the shutdown process. The remote telemetry service (i.e., satellite connection) is also capable of sending a shutdown notice 114 to the PAC.

If one of these inputs 112, 113, 114 shows a fault in startup 115, the PAC sends a signal to shunt trip the main breaker to shut down the system 116. These three inputs are monitored by the PAC whenever the system is in operation. The PAC also monitors the system stop button 117. At any time, if the system stop 117 is pressed after a start command has been initiated, the PAC sends a signal to shunt trip the main breaker to shut down the system. If the start command has been initiated 109, and there are no faults in startup, the sequence to transition from startup to raw gas conditioning 118 is activated.

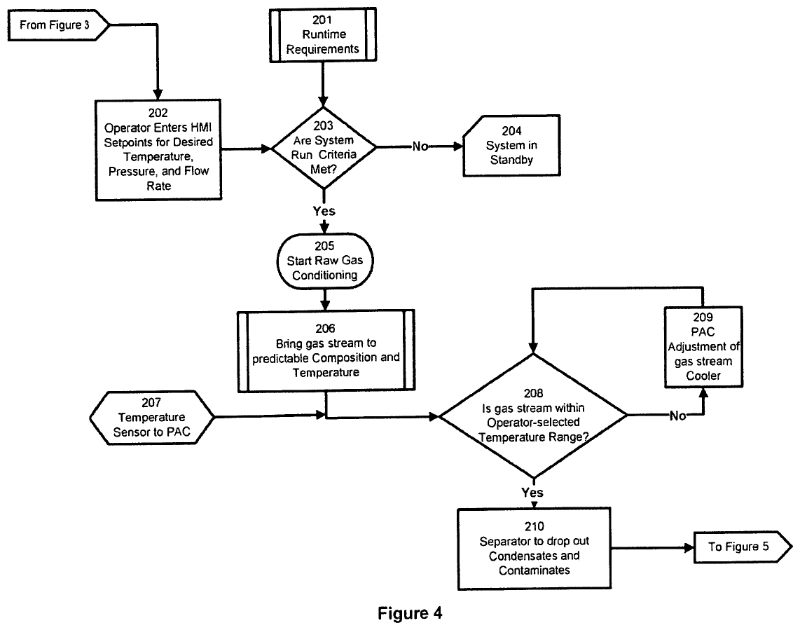

As shown in FIG. 4, there are additional criteria that must be met beyond the startup requirements in order for the system to proceed past the “idle” or “standby” state. These criteria include reservoir oil, heater temperatures, or deltas between ambient and media (gas stream) values 201. These values may not necessitate a system shutdown, but they may require suspension of system operation until the values are within an acceptable range. On the HMI, the operator will input the required parameters and setpoints specific to the wellsite, including, but not limited to, temperature, pressure and flow rates 202.

As noted in the preceding paragraph, a preconfigured list of runtime requirements must be met before starting the raw gas conditioning 203. The system can stay in standby mode waiting for values to come into compliance with requirements 204. When all requirements—both startup (see FIG. 3) and runtime 201—are met, the PAC will activate the first stage compressor 205 (and the associated cooler and separator) to bring the gas stream to a predictable composition by removing condensed liquids and adjusting temperature 206, as discussed above. A sensor reads the gas inlet temperature and transmits that data to the PAC to ensure that gas reaches the setpoint temperature 207. As explained above, the raw gas conditioning system includes one or more aerial coolers, which cool the gas to the operated-selected temperature. If the gas is already cooler than the pre-selected temperature, the aerial cooler fan function is bypassed (i.e., inactive) 208. If needed, the PAC controls the fan speed of the aerial cooler to drop the temperature in the gas stream 209. Condensable components, including water, change phase from a gas to a liquid in a two-phase separator that removes any condensed components and solid contaminants that may exist in the raw gas 210.

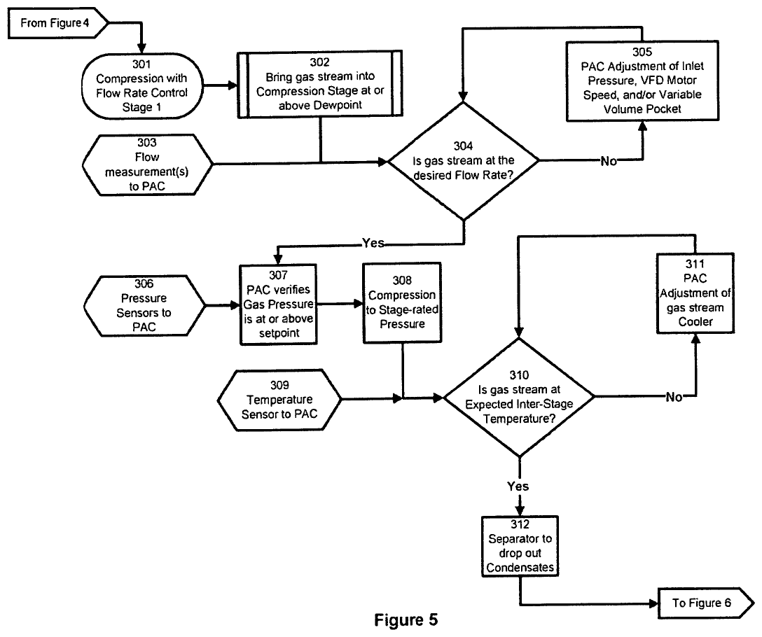

As shown in FIG. 5, the gas stream enters the compression stage(s) with flow rate control 301. As the gas enters the compressor at or above dewpoint, its pressure is elevated in one or more compression stages. Compression of the gas may be effectuated using any type of compressor (e.g., screw compressors, reciprocating compressors, centrifugal compressors, etc.) 302. Flow rate sensors are used by the PAC to control the VFD speed of the compressor 303. The flow rate sensor may be used in conjunction with a lookup table of theoretical response to increase accuracy. The actual flow rate is compared to the desired flow rate target range 304. The PAC adjusts the VFD to control the compressor speed and adjust inlet pressure and/or variable volume pocket (VVP) size of the compressor stage to bring flow rate to the needed—setpoint 305.

A pressure sensor on the outlet end of each stage of compression is read by the PAC to determine whether the gas is at the setpoint pressure 306 for each compression stage. The PAC reads the pressure after the final stage of compression to verify that it is at or above the operator-specified setpoint 307. Gas pressure reduction may be required to meet the requirements of the suction side of the next stage of compression 307. The PAC continually adjusts the control options in 305 (VFD motor speed, inlet pressure and variable pocket size) based on the flow rate sensed at the system inlet and outlet, as well as the pressure and temperature readings being sent to the PAC by various sensors throughout the system. The gas stream enters the first stage of compression 308 and subsequent stages of compression, as needed.

As the gas exits the compression stage(s), the gas temperature is read at the outlet end of the last stage of compression. A temperature sensor transmits data to the PAC, which uses that information to control the compressor functions to ensure that gas reaches the setpoint temperature 309. The PAC compares the actual inter-stage temperature to the desired temperature target range 310. The gas stream is cooled further, if necessary, by using an aerial cooler to process the gas stream until the temperature reaches the desired range 311. The cooling in step 311 may drop out more condensates. The gas-liquid mixture enters a separator, and liquids are separated from the gas 312.

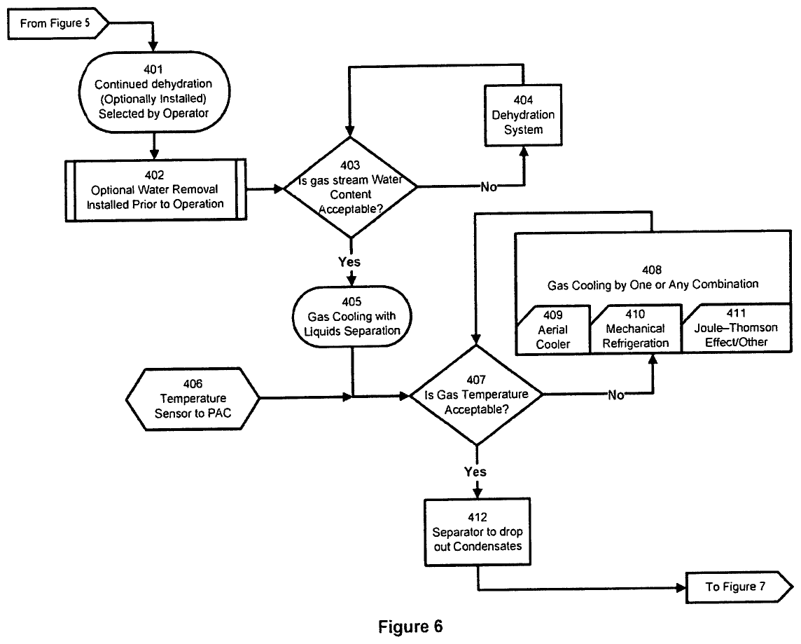

As shown in FIG. 6, there may be additional routing of the flow of gas through a thermally regenerated desiccant system in order to remove water. This dehydration step is optional and can be selected for use or bypassed by the operator 401. Product gas stream enters the dehydration, cooling, and liquid separation phases. Water content of the gas is determined prior to operation, and an optional water dehydration system is installed, if necessary 402. If the water content is not below a pre-defined value, additional dehydration is warranted. If the water content is satisfactory, the dehydration step is bypassed 403. If gas dehydration is necessary, then the gas stream is passed through a dehydration system in order to remove a specified quantity of water as deemed necessary 404. The gas stream then enters additional cooling and liquid separation phases 405, and a temperature sensor is used by the PAC to ensure that the gas at this point has reached the setpoint temperature 406.

The temperature of the gas stream is compared to the setpoint 407. If the value is not acceptable, additional routing through cooling occurs. If the temperature is satisfactory, the gas stream is routed through a separator 407. If additional cooling is required, one or any combination of methods can be employed to provide the most efficient cooling. As the temperature drops, more condensates drop out 408. This decrease in temperature may be effectuated using, for example, an aerial cooler 409, mechanical refrigeration 410, the Joules-Thomson effect or other method known to those skilled in the art 411. Once the gas stream reaches an acceptable temperature, the gas-liquid mixture enters a separator, and liquids are separated from the gas 412.

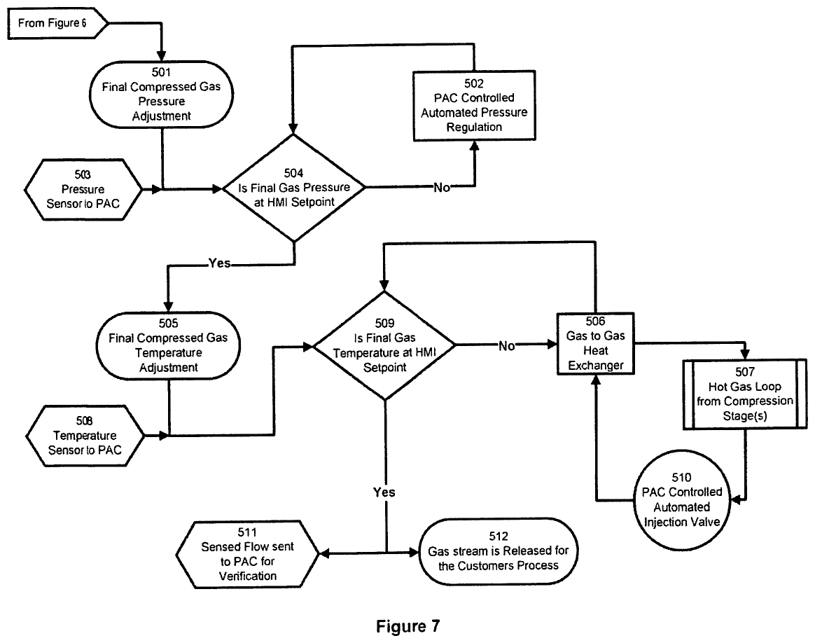

As shown in FIG. 7, the gas stream now enters the final gas pressure adjustment 501. A PAC-controlled automated pressure regulator is used to adjust the final gas pressure to comply with the final gas pressure HMI setpoint 502. The pressure of the gas stream is compared to the final gas pressure HMI setpoint 503. If the value is not acceptable, additional pressure regulation is required. Once the pressure is satisfactory 504, the gas is routed through the final gas temperature adjustment 505, where a temperature sensor is used by the PAC 508 to ensure that the gas at this point has reached the final gas temperature HMI setpoint 509 (explained further below). If temperature adjustment is necessary, the gas stream is routed through the primary (or gas stream) side of a gas-to-gas heat exchanger 506.

The secondary side of the gas-to-gas heat exchanger is used to route heating media gas to effect temperature change of the processed gas stream 507. A hot gas loop using heated gases from the compression stages is used as the heat exchange media to adjust the processed gas temperature 507. The temperature of the product is compared to the final gas temperature HMI setpoint. If the value is not acceptable, additional adjustment using a gas-to-gas heat exchanger is required. If temperature is satisfactory, the gas is released for use by the customer's process. A temperature sensor is used by the PAC to ensure that the gas at this point has reached the final gas temperature HMI setpoint 508. A PAC-controlled automatic injection valve (AIV) 510 is used to control the amount of hot gas that flows through the secondary side of the heat exchanger, thus controlling the extent of the temperature adjustment to the processed gas flowing through the primary side of the heat exchanger 506. Once temperature is satisfactory 509, both pressure and temperature criteria have been met. The outlet flow meter transmits data to the PAC to verify that the resultant gas stream is consistent with customer requirements 511. The gas stream is now ready for use and released for the customer's process 512.

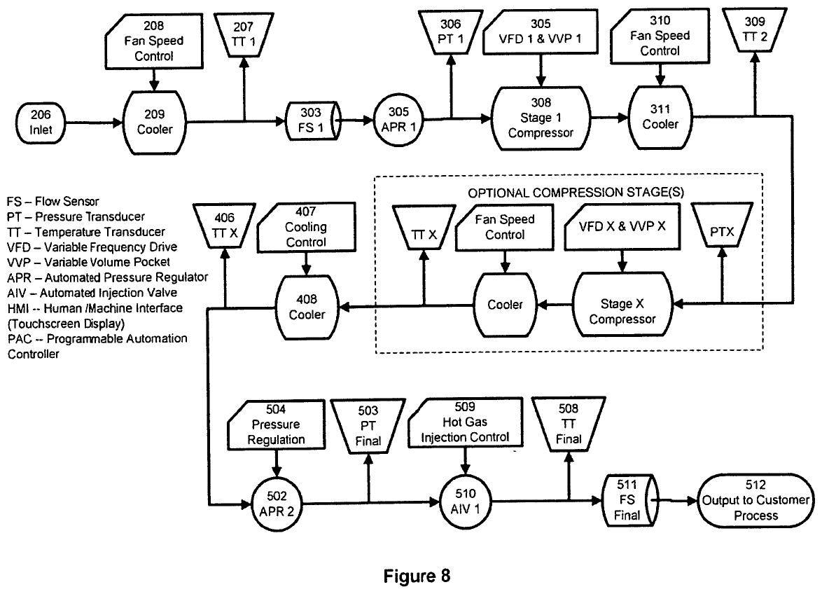

FIG. 8 is a summary diagram of how the PAC acts to maintain control of the system. The gas stream enters the raw gas conditioning system 206, and the PAC uses the reading from a temperature sensor 207 to adjust the fan motor speed on the cooler to bring the temperature into the operator-selected temperature range 209. A flow sensor 303 is used to monitor gas flow and transmit that information to the PAC. The PAC controls the gas flow within the system by altering three factors 305, listed next in order of priority.

The first factor is the inlet pressure, which is controlled by an automated pressure regulator. The automated pressure regulator setting is controlled by the PAC based on the pressure signal received from a pressure sensor 306 to bring the pressure to the appropriate value for entry into the first stage of compression. The second factor is the rotational speed of the compressor, which is controlled by a VFD. The third factor is the VVP adjustment within the compressor. After these three factors are taken into consideration by the PAC and appropriate adjustments are made, the gas stream temperature is then adjusted by the PAC based on the reading from a temperature sensor 309. The PAC changes the fan. motor speed on the cooler 311, to bring the temperature into the expected inter-stage temperature range 310. Additional compression stages may be installed, all of which the PAC controls in the same manner.

After the first stage of compression and any additional compression stages are completed 308, the PAC regulates the final gas pressure 504 of the gas stream with an APR 502 based on the value reported by a final pressure sensor 503. The PAC then controls the amount of hot gas injection 509 through the heat exchanger by sending a value to an AIV 510. This conditions the gas stream to a final gas temperature by raising it to the level needed for the customer process. Final flow 511 is then measured to ensure compliance with setpoints. At this point, pressure, temperature, and flow are in line with the customer's process requirements.

The relationship between temperature and pressure in this application is determined by ideal gas law (P_1 V_1)/T_1=(P_2 V_2)/T_2 wherein the following are true: (1) a change in inlet pressure results in a directly proportional change in flow; (2) a change in temperature results in an inversely proportional change in specific volume; (3) a change in variable pocket volume results in a directly proportional change in flow; and (4) a change in rotational speed results in a directly proportional change in flow. As stated above, this allows the PAC to control all three aspects of pressure, temperature, and flow independently with changes to the automated pressure regulators 305, 502, VFD and VVP 305, and AIV 510, by using information from pressure sensors 306, 504, temperature sensors 207, 309, 406, 508, and flow sensors 303, 511.

### REFERENCES

1. PetroWiki, Society of Petroleum Engineers,

https://petrowiki.org/Gas lift#:˜:text=Gas%20lift%20is%20a%20method,scrubbing%E2% 80%9D%20action%20on%20the%20liquids (2020).

2. Schlumberger Oilfield Glossary, Schlumberger Limited,

https://www.glossary.oilfield.slb.com/en/Terms/g/gas_lift.aspx (2020).

Although the preferred embodiment of the present invention has been shown and described, it will be apparent to those skilled in the art that many changes and modifications may be made without departing from the invention in its broader aspects. The appended claims arc therefore intended to cover all such changes and modifications as fall within the true spirit and scope of the invention.

We claim:

1. A method for conditioning natural gas for downhole applications comprising:
(a) pulling raw gas from a source;
(b) cooling the raw gas to a temperature within a preset temperature range for an inlet of a compressor;
(c) removing any solid contaminants and condensed liquids from the raw gas to produce preconditioned gas;
(d) determining pressure requirements of a suction side of a compressor;
(e) reducing pressure of the preconditioned gas to meet the requirements of the suction side of the compressor using a first automated pressure regulator;
(f) wherein the compressor has a rotational speed, controlling the rotational speed of the compressor based on data input from a flow meter located downstream of the compressor, a flow meter located upstream of the compressor, and one or more transducers located on the suction side of the compressor;
(g) delivering the preconditioned gas to the suction side of the compressor;
(h) elevating pressure of the preconditioned gas to achieve a desired discharge pressure and generate pressurized gas;
(i) using an aerial cooler to cool the pressurized gas, thereby causing liquids to form;
(j) delivering the pressurized gas to a separator to separate the liquids from the preconditioned gas;
(k) repeating the steps of elevating pressure of the preconditioned gas through a series of compression stages to achieve a desired discharge pressure and generate pressurized gas, using an aerial cooler to cool the preconditioned gas, and delivering the preconditioned gas to a separator to separate liquids from the preconditioned gas until a gas stream having a desired gas temperature and a desired pressure is achieved;
(l) cooling the pressurized gas by using a first temperature sensor to send a signal to the programmable automation controller to maintain a desired temperature set by an operator and generate cooled gas through the use of a heat sink;
(m) removing liquids from the cooled gas through the use of a separator to generate conditioned gas;
(n) wherein the conditioned gas has a pressure, adjusting the pressure of the conditioned gas by using a pressure sensor located in the gas stream to send a gas supply pressure signal to the programmable automation controller and using the programmable automation controller to control a second automated pressure regulator to adjust the pressure of the conditioned gas without affecting the flow rate of the conditioned gas; and
(o) adjusting the temperature of the conditioned gas by using a second temperature sensor situated in the gas stream to send a signal to the programmable automation controller to increase the temperature of the conditioned gas using an automated injection valve situated between the series of compression stages and a heat exchanger to achieve an exit temperature specified by the operator for the conditioned gas.

2. The method of claim 1, further comprising the step of removing water from the pressurized gas through the use of a dehydration method.

3. A system for conditioning natural gas for downhole applications comprising:
(a) a programmable automation controller configured to accept operator-input specifications for desired gas outlet pressure, desired gas outlet temperature, and desired gas outlet flow rate and to independently control each of these three parameters;
(b) one or more gas pressure sensors, one or more gas temperature sensors, and one or more gas flow meters configured to transmit data to the programmable automation controller;
(c) a first aerial cooler configured to adjust temperature of pre-conditioned gas;
(d) a first separator configured to remove liquids from the pre-conditioned gas;
(e) a first automated pressure regulator configured to regulate inlet pressure of the pre-conditioned gas;
(f) a compressor having a first stage of compression with a variable volume pocket, the compressor being configured to receive and compress the pre-conditioned gas, thereby increasing pressure and temperature of the pre-conditioned gas to generate pressurized gas;
(g) an external heat sink configured to decrease temperature of the pressurized gas to generate conditioned gas;
(h) a second automated pressure regulator configured to reduce pressure of the conditioned gas to the desired gas outlet pressure; and
(i) a heat exchanger configured to increase temperature of the conditioned gas to the desired gas outlet temperature;
wherein the PAC is further configured to control pressure, rotational speed and pocket size of the compressor to achieve the desired outlet gas flow rate.

4. The system of claim 3, wherein the compressor has one or more compression stages, the invention further comprising an additional aerial cooler and an additional separator for each additional stage of compression beyond the first stage of compression.

5. The system of claim 3, further comprising a gas dehydration unit configured to remove water from the pressurized gas.
